(19) United States
(12) Patent Application Publication
(10) Pub. No.: US 2018/0215926 A1
(43) Pub. Date: Aug. 2, 2018

(54) Ice Removal Devices Including Icephobic Coatings

(71) Applicants: Michael H Gurin, Glenview, IL (US); Anish Tuteja, Ann Arbor, MI (US)

(72) Inventors: Michael H Gurin, Glenview, IL (US); Anish Tuteja, Ann Arbor, MI (US)

(73) Assignee: HygraTek LLC, Northbrook, IL (US)

(21) Appl. No.: 15/419,637

(22) Filed: Jan. 30, 2017

(51) Int. Cl. C09D 5/00; B08B 7/02; B08B 7/00; B60S 1/02; F03D 80/40; B64D 15/00

(52) U.S. Cl. CPC C09D 5/00; B08B 7/02; B64D 15/00; B60S 1/023; F03D 80/40; B08B 7/0071

(57) ABSTRACT

Icephobic coatings that reduce ice adhesion strength must also enable ice delamination to ensure effective ice removal, especially when adjacent areas are not coated with icephobic coatings in which case an ice bridging preventer must also exist. The resulting mechanical devices ensure ice removal by leveraging specific ice delamination propagation features of the icephobic coating.

### FIELD OF THE INVENTION

The present disclosure relates to the icephobic coatings (or broadly defined as surface properties that reduce ice adhesion strength relative to non-modified surface properties) and the specific application of the icephobic coatings into mechanical devices that integrate mechanical features for the removal of ice buildup on the mechanical device as uniquely enabled by icephobic coatings.

The buildup of ice, particularly glazed ice, once initiated on any portion of the mechanical device enables further ice buildup on top of the initial ice formation (i.e., the presence of the icephobic coating only has an impact when it is the most external facing substrate). Therefore, the potential exists for the ice to buildup despite the presence of an icephobic coating having very low ice adhesion strength (e.g., even lower than 20 kPa).

### BRIEF DESCRIPTION OF THE DRAWINGS

These and other objects, advantages, and features of the present invention will be more readily understood from the following detailed description of the preferred embodiments thereof, when considered in conjunction with the drawings, in which like reference numerals indicate identical structures throughout the several views, and wherein:

FIG. 1 depicts the components of an active control system to ensure ice removal via ice delamination propagation.

FIG. 2 depicts a cross-sectional view of a coated substrate having an embedded resistive heating element.

FIG. 3 depicts another cross-sectional view of a coated substrate having an infrared emitting element.

FIG. 4 depicts yet another cross-sectional view of a coated substrate with an actuator creating an ice delamination force.

FIG. 5 depicts a top view of a substrate having a coating matrix.

FIG. 6 depicts a cross-sectional view of a coated substrate with an external flexing force.

FIG. 7 depicts another cross-sectional view of a coated substrate with an external flexing force such as occurring on a rotating mechanical device (e.g., wind turbine).

FIG. 8 depicts another cross-sectional view of a substrate having a coated matrix with an external actuator force.

FIG. 9 depicts a cross-sectional view of a coated substrate with an icing bridge preventer such as a gasket.

FIG. 10 depicts a cross-sectional view of a coated substrate with a flexible gasket and actuator creating an ice delamination propagation force.

FIG. 11 depicts a graph representing actuator force by internal ice stress.

FIG. 12 depicts a cross-sectional view of a coated substrate with a flexing gasket to reduce ice formation below the substrate and enhancing ice thinning of any ice bridging.

FIG. 13 depicts a cross-sectional view of a coated substrate, without a gasket, depicting ice bridging.

FIG. 14 depicts a cross-sectional view of a coated substrate with a flexing gasket to reduce ice formation below the substrate and enhancing ice thinning of any ice bridging from a closed position to a fully open position (while showing an intermediary position).

### SPECIFICATION

This invention features multiple embodiments of mechanical devices integrating icephobic coatings that have been applied onto at least a portion of the mechanical device exposed (i.e., facing) the environmental conditions such that ice formation can buildup on the exposed surface. The coatings are applied by means known in the art including spray-coating, dip-coating, spin-coating, chemical vapor deposition, plasma deposition or flow-coating techniques on various substrates, and treated in the presence or absence of heat, radiation (UV-VIS, IR, and electron beam), light or electrical energy to obtain durable, water resistant, transparent and hydrophobic coatings that exhibit extremely low ice adhesion strength (<150 kPa). The chemicals, as known in the art, typically used in an icephobic surface coating can also be embedded into the bulk of a chemical (typically a polymeric matrix) onto a mechanical device, such as a rubber gasket or windshield wiper blade, where abrasion “away” (i.e., abrading the top most layer and then exposing layers below) of the externally exposed surface does not eliminate or reduce the ability of the now exposed surface to maintain a low ice adhesion strength.

The range of mechanical devices is not limited, though exemplary applications include: ice makers, evaporators, wind turbines, airplane wings, high voltage power lines, telecommunication lines, water dams, and transportation components including embedded cameras, door latches, door seals, and door locks.

### SUMMARY OF THE INVENTION

This section provides a general summary of the disclosure, and is not a comprehensive description of its full scope or all features.

The present invention overcomes an often occurring ice bridging formation (the formation of ice on top of an initial ice formation over the substrate, even when the substrate is coated with an icephobic coating, such that the ice itself bridges onto itself or onto a substrate that is void of an icephobic coating on a mechanical device, which effectively renders the icephobic coating practically useless, particularly when the icephobic coating is only on a first substrate and not on a second adjacent substrate.

Another embodiment of the invention initiates a weak spot within an ice buildup, which enables the built-up ice formation to crack in a favorable/strategic location/position such that any adverse ice bridging impact is reduced by a tangential force being applied at that crack position.

Yet another embodiment of the invention is an application of the icephobic coating into a matrix pattern such that the effective width (or broadly the effective area) is reduced into a series of smaller width area within the total substrate area to encourage ice buildup delamination by a delamination force of the now smaller effective width and the length of the substrate at least 10% less than the total substrate area such that the region that first experiences ice delamination enables the delamination area to propagate throughout the total substrate area.

A further embodiment of the invention is selective application of resistive heating elements as an alternative method to reduce the effective width such that an initial ice buildup delamination occurs and propagates beyond the initial region for the ice delamination to continue into the remaining region which has the icephobic coating.

Yet a further embodiment of the invention is the application of an icephobic coating having significantly enhanced durability such that a first icephobic coating has a higher durability and has a higher ice adhesion strength than a second icephobic coating, yet the application of the first icephobic coating over a larger area than the second icephobic coating (by way of a reduced effective substrate area) performs by delamination propagation at an effectiveness of at least 50% equivalent to if the substrate was coated entirely with the second icephobic coating yet without the durability of meeting the application requirements for long-term performance.

The fundamental benefit of the invention is to limit ice buildup beyond a safe operating limit such that the ice buildup doesn't prevent the opening and/or closing of a component within the mechanical device. or an excessive ice mass buildup that can adversely impact aerodynamic lift or excessive weight gain to adversely impact the structural integrity of the mechanical device, or an excessive force requirement to displace the ice from within the mechanical device without the typical “defrost” consumption of thermal energy to first melt virtually the entire ice formation prior to the release of the ice buildup from the total substrate are of the mechanical device.

### DETAILED DESCRIPTION

As discussed earlier, this invention discusses a process of applying the use of icephobic coatings that are suitable for reducing ice buildup on a wide range of mechanical devices. The invention also addresses a novel application of the coating in strategic locations to ensure safe and optimized operation of the mechanical device across its entire operating envelope. It is a primary objective of the invention to greatly reduce the amount of force, preferably to a force that would reduce/eliminate the utilization of an external actuator even in the event of ice bridging. Example embodiments will now be described in more detail.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for describing and characterizing exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore, specify the presence of stated features, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters.

As referred to herein, ranges are, unless specified otherwise, inclusive of endpoints and include disclosure of all distinct values and further divided ranges within the entire range.

The term “upper ice force threshold” is the maximum force that is applied to the ice sheet in which the ice sheet will break from within the sheet itself (at least within the length in which the desired physical separation from the substrate is desired hereinafter also referred to as the “ice separation propagation direction”, which is a function of ice thickness, local ice temperature, type of ice, ice density, and impedance value that is a result of the aforementioned ice sheet physical parameters.

The term “lower ice force threshold” is the minimum force required in which ice crack propagation will occur, that being at the physical conditions ice thickness, local ice temperature, type of ice (e.g., glaze or rime), ice density, and impedance value that is a result of the aforementioned ice sheet physical parameters and the substrate icephobic coating ice adhesion strength. It is understood that the lower ice force threshold can established by the ice sheet impedance as measured by an impedance sensor as known in the art (U.S. Pat. No. 7,439,877). The presence of flaws, cracks, or voids in the ice increases significantly the likelihood of premature (or undesirable breaking of the ice sheet) such that ice separation propagation direction is prevented throughout the entire area in which ice removal is desired.

The term “void of ______” means the absence of ______.

The actuator generating a delamination propagation force “delamination force” can be at a range of angles to the ice sheet, such that at least 10% of the applied force is perpendicular to the ice sheet. Preferably the delamination force is at least 50% of the applied force, and specifically preferred at least 90% of the applied force. All things equal, the ice sheet with lower thickness, or density is more susceptible to breaking, in which case less tangential force from the actuator is allowed relative to the total actuator force. However, the lower the tangential force required to begin delamination propagation will require a higher total actuator force (which is the additive force vectors of tangential force and shear force). Yet when the benefit of substrate flexing is present along at least the delamination propagation direction (and preferably maximized in the tangential direction and parallel to the effective length), the total actuator force is reduced relative to requirement when no such substrate flexing takes place. All things equal, the substrate flexing force is away from the ice sheet (i.e., the flexing of the substrate due to mechanical device operating forces is tangentially creating a displacement force separating the substrate from the ice sheet). The particularly preferred embodiment in a wind turbine (or airplane wing) is to slow down the rotational speed (or decrease in flight speed) when the wind turbine is a flexible airfoil to increase the separating force of the “top” ice sheet. The increase of rotational speed (or increase of flight speed for an airplane wing such as a flexing wing on the Boeing Dreamliner 787).

The actuator generating the delamination force is preferably combined with a surface acoustic wave sensor to respectively confirm and/or establish the upper ice force threshold and the lower ice force threshold. The surface acoustic wave sensor is preferably both a method of displacing water (i.e., pre-ice freezing by way of the surface acoustic waves generated, doubling as ice sensor preferably an ice inductance sensor) from the substrate and of measuring (or at least confirming first the ice adhesion to the substrate and then to a reduction of ice adhesion indicative of the at least beginning of) displacement of the ice sheet from the icephobic coated substrate.

It is further understood that other physical parameters can be used to establish proper operations between the lower ice force threshold and upper ice force threshold such that adequate but not too much force initiates the ice separation propagation direction along the substrate without breaking the ice sheet in at least one place that establishes a physical crack in the ice sheet preventing the ice separation propagation from occurring tin the desired direction.

A thermoelectric device operable to melt ice or to condense water (both available to be utilized to harvest cleaning fluid), such that preferably no externally filled reservoir (by a human or robot) is required. It is understood that an initial filled level is within the anticipated practice, such that the bulk (at least 50%) of the fluid utilized to clean the camera (or sensor including Lidar, radar, etc.).

The system is preferably comprised of a gasket having an ice adhesion strength less than 100 kPa, and particularly preferred such that the gasket is in a compressed mode such that the gasket either operates as a bridge prevention device while compressed or at least such that prior to physical displacement of the compressed gasket (i.e., when having ice attached to the gasket) a stored energy enables subsequent flexing and removal force by the gasket to take place in addition to the force of the physical displacement actuator are both applied to breaking any present ice bridge thus enabling at least partial deployment of the displacement device from the second substrate (e.g., fuselage/hood of an automotive vehicle). The use of a gasket comprised of an icephobic coating and/or comprised entirely of an icephobic polymer is insufficient to enable the at least partial displacement of the displacement device from the second substrate. The particularly preferred icephobic gasket is electrically conductive such that resistive heat reduces the ice thickness of any ice that bridges between the displacement device and the second substrate. The icephobic coating on a portion of the substrate is comprised of a first icephobic coating and a second icephobic coating such that the ice adhesion strength of the first coating is at least 5 percent lower than an ice adhesion strength of the second portion, and such that the icephobic coating is at least 0.001 inches above the second portion icephobic coating in height.

The icephobic device, which is interchangeably referred to as the host mechanical device, has a total substrate area that is exposed to icing environmental conditions (which ranges from frost to glazed ice) can have multiple coatings that has varying surface properties depending on the primary function. The best icephobic coatings, those that have the lowest ice adhesion strength most often have relatively lower durability as compared to non-icephobic coatings. Therefore it is desirable to reduce the amount of coated substrate having the lowest traditional ice adhesion strength but rather to utilize an icephobic coating having the lowest effective ice adhesion strength by designing/applying an ice delamination propagation coating on a optimally designed component(s) to limit ice bridging and maximize ice removal with relatively minimal physical force acting as an ice removal mechanism (typically an actuator or inherent flexing of the substrate) such that the ice removal mechanism physically displaces any occurring ice buildup and such that the initial displacement area of the ice buildup from a portion of the icephobic coating propagates beyond that initial displacement area of the ice buildup into an ice release propagation area by at least 5 percent beyond the initial displacement area.

An actuator is most often the ice removal mechanism, however it can be any mechanism that creates a physical force onto the ice buildup whether the physical force is a shear or tangential force including a force created by an external airflow, a flexing of an at least one structural element (in physical contact or structural communication) on the host mechanical device within the icephobic device due to rotational forces or an external airflow force acting on the icephobic device, an external gravitational force due to increased mass loading from the ice buildup, or the combination of both rotational and gravitational forces.

### Examples

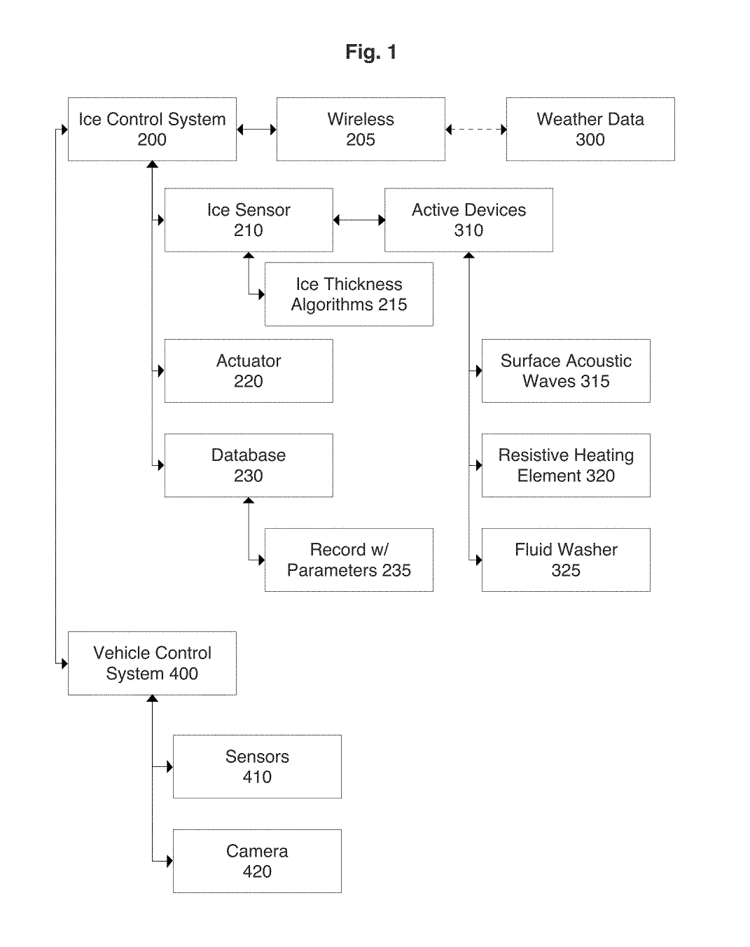

Turning to FIG. 1, a specific control system is required to manage ice removal where ice delamination propagation is leveraged as compared to an uncoated or traditional icephobic coated substrate, notably an ice crack stops the propagation of ice delamination. Therefore, the specific control system must minimize ice bridging (or at least reduce the thickness of the ice bridge) and ensure that any ice buildup is sufficiently thick enough to prevent ice cracking prematurely. The ice control system 200 leverages real-time (or historic or predicted) weather data 300 preferably through wireless 205 communication methods as known in the art. The combination of real-time weather data with on-board ice sensor(s) 210 enable the reduction of either number of sensors, expense of sensors, or increase of determining ice threshold parameters as depicted elsewhere in this invention. As noted earlier, it is critical to leverage the ice sensor(s) 210 to accurately determine ice thickness and ice strength to establish ice cracking regions and forces. The ice thickness algorithms 215 establish the operations of active devices 310 including surface acoustic waves 315, resistive heating elements 320, and fluid washers 325. The ice control system 200 in combination with ice thickness algorithm 215 (which includes numerous ice parameters such as ice strength, ice density, ice thickness, etc.) which varies in accordance to temperature (and further considers predicted future temperature, solar irradiation, driving plans, etc.) to vary the position (and force generated) by an actuator 220. The aforementioned parameters are stored in a database 230 in multiple records with parameters 235 to increase accuracy whether it be actual historical records or additional temperature, atmospheric pressure, relative humidity readings (or additional sensor values) for determining critical ice delamination propagation force, ice cracking force (so as to avoid premature ice cracking that would limit ice delamination propagation. The ice control system 200 also leverages host camera(s) 420 or sensor(s) 410 through the host system, such as a vehicle control system 400 in a transportation device (e.g., car, truck, airplane, etc.) or used interchangeably with a wind turbine (though not shown in the figures). The actuator (a.k.a. ice removal mechanism) creates a physical force on the ice buildup at an angle of at least 5 degrees upwards (i.e., tangential force) from the first portion coating towards the second portion coating. The physical force applied must be at least 0.01 psi greater than that required to displace the ice buildup and at least 0.01 psi lower than in which the ice will crack on the first and/or second portion coating. The actuator preferably exerts a pulling force on the ice buildup prior to exerting a pushing force on the ice buildup as a method to increase by at least 0.01 inches a crack in the ice buildup to free up the movement between the first and second sections (i.e., the crack in the ice buildup is within the ice bridging area which overlaps by at least 0.001 inches the first portion coating and the second portion coating).

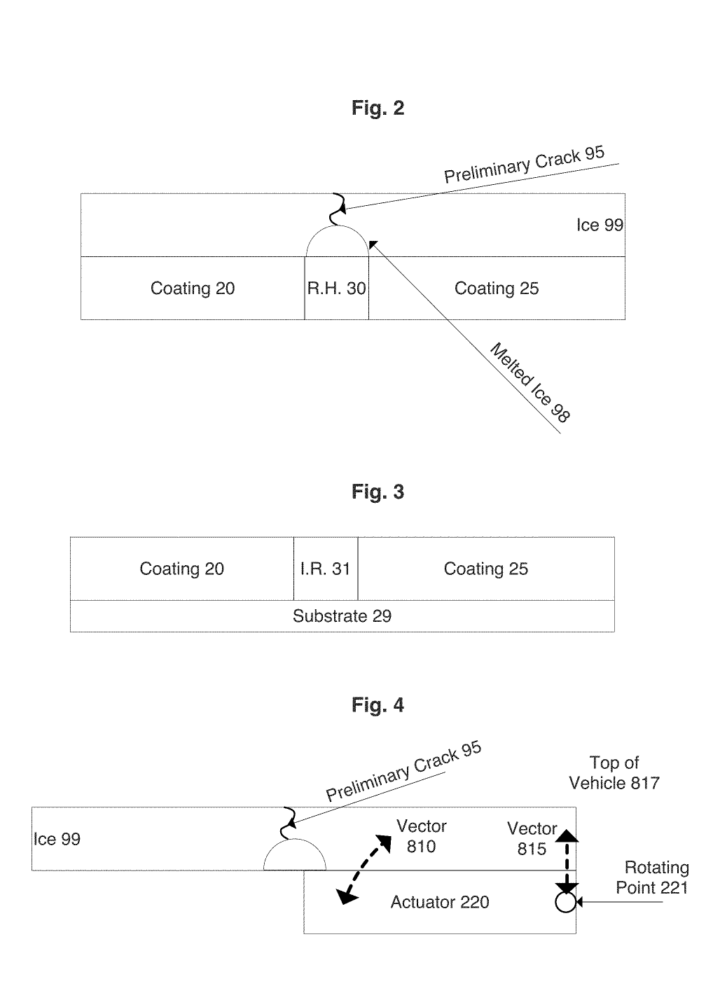

Turning to FIG. 2, a first coating 25 on a substrate (not shown in this figure below the coating) is an icephobic coating that enables ice delamination propagation to occur. Adjacent, and in between the first coating 25 and second coating 20 (which is understood to also include a non-coated surface), is a resistive heating 30 element to create a localized crack (or at least a zone in which the ice thickness is reduced) such that when a force is applied onto the first coating 25 area (or propagated through the first coating area 25) the ice 99 film/sheet is able to have a lower total ice adhesion strength as ice adhesion strength is typically a function of total area in which the ice 99 has “grown” onto the substrate. The preferred use of the resistive heating element 30 is highly localized to where the preliminary crack 95 is desired and occurs by localize melted ice 98 to also reduce ice bridging from first coating 25 area to the second coating 20 (or uncoated) area.

Turning to FIG. 3, which is essentially identical to FIG. 2 with the exception that the substrate 29 is clearly shown and that the resistive heating element 30 is replaced by infrared 31 emitter to accomplish the same functionality of establishing a localized preliminary crack 95. The infrared emitter is preferably an infrared LED (light emitting diode so as to provide precision in emitting direction and to minimize energy consumption), between the first portion coating and the second portion coating to create (or expand) a preliminary crack within the ice buildup preferably in the region in which ice bridging occurs so as to minimize thermal dissipation, or more importantly to direct infrared “beam” such that as ice melts and contact is removed between the ice buildup and otherwise resistive heating element, ice melting (and particularly increasing the ice crack thickness continues; also importantly the absorption of ice of infrared spectrum enables the infrared emitter to be part of the ice thickness detection system (reduces cost of additional sensor). It is known in the art that an infrared LED can diffuse lighting across a wider area by utilizing known in the art waveguides.

Turning to FIG. 4, also essentially identical to FIG. 2 and FIG. 3, shows the substrate in structural communication (depicted as one of the same) to an actuator 220. The preferred embodiment is such that the actuator creates a rotational force as shown by vector 810 first which preferentially maximizes the force to encourage the preliminary crack 95 in the ice bridging region. After rotating on a pivot point (rotating point 221) and creating a crack (i.e., breaking the ice bridging) a second force (which will typically be lower than the first force vector 810) vector 815 is applied. In this embodiment, which is for a housing “containing” a sensor or camera to limit direct exposure to the outside environment (e.g., ice, dust, dirt, etc.) on a transportation vehicle the top of the vehicle 817 is closer to the first coating 25 (not shown on this figure but on FIG. 2) relative to the second coating 20 (or uncoated region) such that gravity further displaces the ice sheet/film 99 once the ice bridge is broken and the ice delaminates off the first coating 25 area.

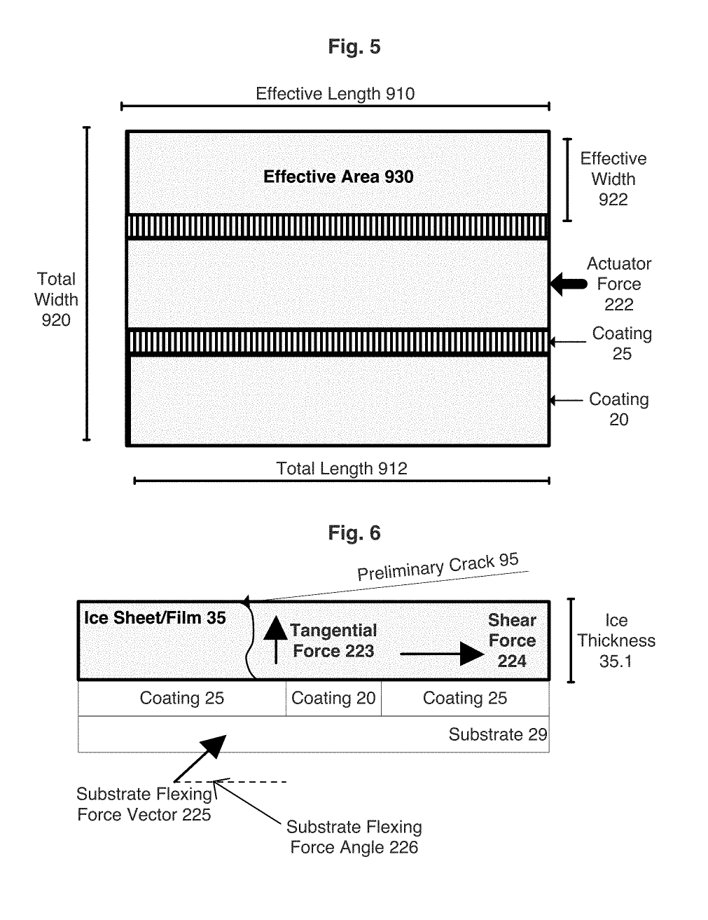

Turning to FIG. 5, depicts a representative area comprised of a total width 920, and a total length 912 multiplied out into the total area. However this total area is “broken” into a smaller effective area 930 comprised of an effective length 910 and effective width 922. The segmentation into a smaller effective area is done by a coating matrix pattern having a first coating 25 and a second coating 20. The first coating 25 in the preferred embodiment has a lower ice adhesion strength (at least less than 0.001 kPa differential, preferably at least less than 10 kPa, and particularly preferred at least less than 20 kPa lower than second coating ice adhesion strength) than the second coating 20, though often to realize this lower ice adhesion strength the coating itself is less durable than the second coating thus needs to be minimized so as to not be worn away during operations of the host mechanical device in which the coatings are on. The preferred second coating enables ice delamination propagation to occur such that the ice adhesion strength is effectively at least 10% lower than the ice adhesion strength in the absence of the second coating 20 than the ice adhesion strength of the total area without any ice delamination propagation. The particularly preferred reduction of effective ice adhesion strength is at least 20% lower than the ice adhesion strength in the absence of ice delamination propagation mode, and specifically preferred reduction of the effective ice adhesion strength is at least 80% lower. The ice delamination propagation mode achieves a ice adhesion strength that is largely a function of the effective width 922 and becomes relatively independent of the total length 912 or even the effective length 910, therefore the orientation of the resulting second coating 20 and first coating 25 is largely in parallel with the effective length 910 (such that the effective length 910 is at least 10% greater than the effective width 922, specifically preferred to be at least 80% greater). The effective width by leveraging delamination propagation achieves a reduction of the width by at least less than half of the total substrate area width.

Turning to FIG. 6, depicts the representation of forces relative to the coated substrate to minimize the force required to initiate the ice delamination and to maintain a minimal force as the ice delamination propagates in parallel along the effective length 910 (as shown on FIG. 5). The large reduction of effective ice adhesion strength due to ice delamination propagation requires the ice sheet/film 35 to not expand the preliminary crack 95 when the applied force to remove the ice sheet/film 35 to the point in which the ice delamination propagation ends prior to removal of the ice sheet/film 35 throughout the desired (and presumably) total area (as shown on FIG. 5). Minimization of the force vector required to start the ice delamination occurs when the substrate 29 flexes to create a highly localized tangential force 223 (and a relatively minimal shear force 224, such that the tangential force is at least 10% greater than the shear force and particularly preferred to be at least 50% greater than the shear force during at least the beginning of the ice delamination from the coated substrate). In an application, such as an ice maker, maintaining the minimal force of the flexible substrate is achieved such that the substrate flexes in a manner that the substrate continues to slowly move away (preferably, but can also be towards) in a “rolling” manner. The substrate flexing force vector 225 (though depicted towards the substrate is preferred to be at a similar substrate flexing force angle 226) but 180 degrees rotated as shown. The ice sheet/film 35 must be at a sufficient ice thickness 35.1 such that the ice sheet/film 35 doesn't break for the applied force to enable the ice sheet/film 35 to delaminate and propagate across the entire total area (or at least the required area within the total area but greater than the effective area 930 (as shown in FIG. 5).

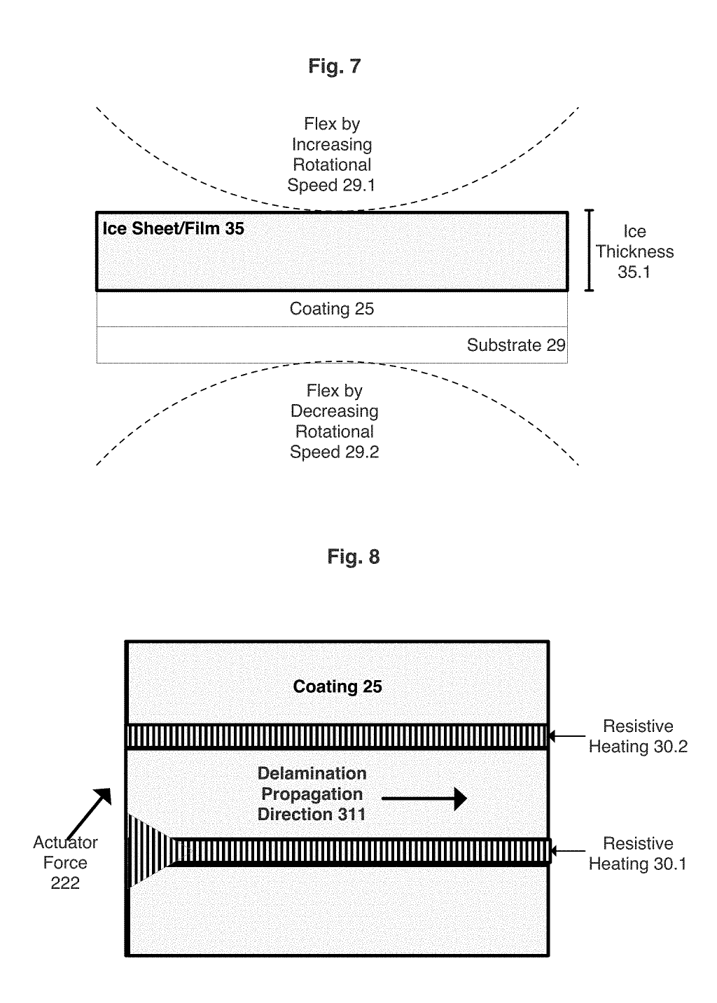

Turning to FIG. 7, depicts a rotating application such as a wind turbine or helicopter/drone airfoil. The particularly preferred embodiment is the airfoil (i.e., turbine blade or airplane wing) has physical flexing by at least 5% (and preferred by at least 10%) of the entire displacement angle particularly especially in the regions susceptible to ice buildup. The flexing of the airfoil creates a tangential force 223 (as shown on FIG. 6) without the use of any external actuators. Altering the rotational (or in the event of an airplane the velocity of the airplane) speed of the turbine blade, as known in the art for a wind turbine by reducing the electricity power generation for the given wind velocity to increase the rotational speed, the wind turbine blade will flex 29.1. A decrease in rotational speed will reduce the flex 29.2 also creating a tangential force to enable ice delamination propagation. The coating 25 on the substrate 29 is shown as a singular coating but is understood to be optimal as a coating matrix of a first coating 25 and a second coating 20 (depicted on other figures).

Turning to FIG. 8, depicts another embodiment of the coating matrix such that the coating 25 is an icephobic delamination propagation coating (has a relatively higher ice adhesion strength as compared to non-delamination propagation coatings, but much higher durability particularly an icephobic delamination propagation coating that can survive rain (and/or wind) erosion testing as known in the art. In this instance, rather than a second coating (having an even lower ice adhesion strength), a resistive heating element 30.2 is embedded into the total area (or even embedded into the coating 25) selectively (though much preferred to be in parallel with the actuator force 222 (understood such that actuator force can be a non-external force created by the flex of the substrate as depicted in FIG. 7). In the particularly preferred the resistive heating element 30.1 is tapered to reduce further the effective width to initiate the ice delamination propagation and thus the actuator force 222 required substantially as compared to a non-ice delamination propagation coating. As a comparison, a wind turbine icephobic coating requires an ice adhesion strength of less than 5 kPa (and in virtually all instances less than 2 kPa) to remove the ice buildup at traditional operating speeds and thus the G-forces on the ice and turbine blade are insufficient to remove the ice. The inventive ice delamination propagation coated mechanical device reduces the amount of resistive heating element coverage (and power) by at least 10% (and particularly preferred by at least 90%) compared to traditional resistive heating over the entire total area. It is imperative though that the ice delamination is initiated when the ice sheet/film is sufficiently thick (i.e., ice strength threshold so that the ice doesn't expand any preliminary cracking along the effective length corresponding to the delamination propagation direction 311 especially when the resistive heating element 30.1 creates an expanded resistive heating area i.e., tapered so as to further reduce the effective width by at least 10%).

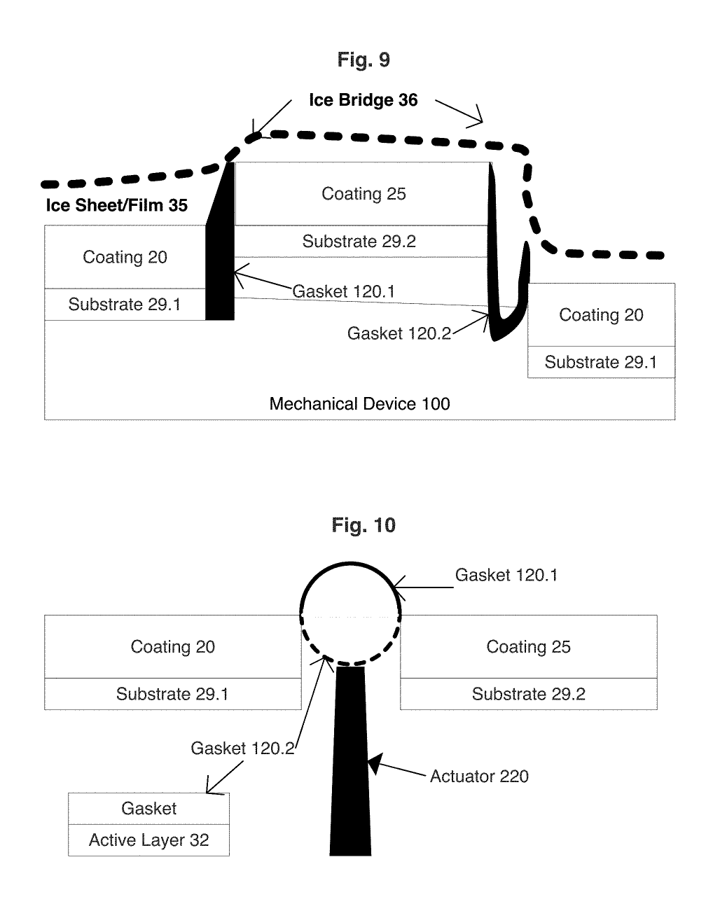

Turning to FIG. 9, depicts ice bridging formation between a first coated section 25 and a second coated section 20 (or even where coating 20 is a non-icephobic coated substrate or a bare substrate). A critical issue in many applications is such that a component within the host mechanical device is manufactured by one supplier and an adjacent component is manufactured by yet another or that second adjacent component has different surface property requirements (or even no special requirements to minimize adjacent component cost by eliminating the requirement for special ice delamination propagating coatings) in which case ice buildup occurs on at least coating section 20. Ice buildup can also occur over any icephobic coating (such as when the component is horizontal, even if the icephobic coating has a virtually non-existent ice adhesion strength i.e., less than 0.1 kPa) and then ice buildup continues to occur on top of any existing earlier ice effectively making the component coating 25 useless. This formation of ice buildup from one coated first section to another coated/un-coated section is referred to as ice bridging as indicated by ice bridge 36. Under this scenario, if there was an actuator placing a force perpendicular to the first coated section 25 (on the substrate 29.2) the force required to remove the ice buildup is not only the total area by the ice adhesion strength (though in our inventive use of ice delamination propagation coating it would be the effective area only) and also the total area of the second coated area 20 (on the substrate 29.1) by the ice adhesion strength of that coating 20 (or un-coated surface) component within the entire host mechanical device 100. The inventive embodiment further utilizes an ice bridging preventer between at least a portion outlining the perimeter of the first coated section 25 and the second coated section 20 in this instance the ice bridging preventer is a gasket 120.1 (a.k.a. ice crack propagator where the bridging preventer reduces by at least 0.001 inches the ice buildup thickness over the at least one ice crack propagator “gasket”) that serves to minimize the ice bridge 36 thickness by at least 10% of the ice thickness (and particularly preferred to be at least 50%, and specifically preferred to be at least 80%, and far superior when it is at least 100% of the ice thickness). The inventive gasket 120.1 is comprised of a low ice adhesion strength material that is preferably a multi-chemical rubbery material having a ice adhesion strength that is less than 40 kPa (and preferably less than 20 kPa, and specifically preferred less than 10 kPa) such that any wear on the gasket remains icephobic throughout the bulk of the material (extending the effective lifetime of the material). The preferred ice bridging preventer, in the event of not being of sufficient durability for long-term sustained environmental exposure is at least partially retracted such that the active control system extends the ice bridging preventer selectively during times in which ice buildup is predicted or occurring). The particularly preferred embodiment is where the first coated section 25 and the ice bridging preventer gasket 120.1 are in structural communication such that the first coated section is extended outward to continue to reduce the ice bridge thickness to at least 10% thinner (and preferably at least such that the top of the ice bridging preventer is at least 0.01 inches above the top of the ice buildup over the second coated section 20). The very low ice adhesion strength to the gasket 120.1 (or also gasket 120.2) ensures that the ability to move the first coated section 25 relative to the second coated section 35 only requires a force to either propagate the preliminary crack 95 (as depicted in other figures) through the entire ice buildup thickness (now at the reduced thickness relative to the second coating 20 section ice thickness) or only the much smaller force to overcome only ice adhesion on the ice bridging preventer gasket (120.1 or 120.2) which is at least 80% lower than even the ice adhesion total force of the first coated section 25. An embodiment of the ice bridge preventer is the utilization of a gasket rubbery material that is further comprised of additives making the gasket as an integral resistive heating elements operable to further reduce the ice bridge thickness. The gasket 120.1 in another embodiment remains in a fixed position relative to second coated component 20 (i.e., in structural communication with the second coated/un-coated component 20) yet projecting outward by the design ice buildup thickness specification. Yet another embodiment is such that the gasket 120.1 is not in structural communication with either first coated component 25 or second coated component 20 so that it is virtually invisible during periods of time in which no ice buildup is predicted or occurring therefore not having negative visual impact on mechanical device 100 appearance. Another embodiment is such that the gasket 120.2 is in structural communication with the first coated section 25 where this gasket 120.2 embodiment differs from the other gasket 120.1 by having a U-shape so that limited (or preferably no) ice buildup can occur within the gap (or below, by passing in between) between first coated section 25 and second coated section 20. It is particularly preferred such that the icephobic gasket is also comprised of a hydrophobic coating to limit water or melted ice from subsequently forming ice below (and further preferred such that interior spaces/gaps between the two coated sections also have hydrophobic coatings to limit refreezing).

Turning to FIG. 10, depicts another embodiment of the ice bridging preventer such that it is a gasket 120.1 capable of stretching/flexing to limit ice (or even water passing) buildup between the first coated section 25 (on substrate 29) and the second coated section 20 (on substrate 29). The flexible gasket 120.2 can optionally have an active layer 32 (which can be any method of heating the gasket to limit ice bridge thickness including a resistive heating element). The ice bridging preventer gasket 120.1 is extended by an actuator 220 creating a force sufficient to propagate the preliminary crack 95 (not shown) and break the ice bridge freeing the first coated section 25 for movement relative to the second coated section 20 (on their respective substrates 29.2 and 29.1). This embodiment is of particular benefit when a minimal travel distance is required (less than 1 inch, preferably less than 0.5 inch) while ensuring that the first section is flush with the second section. The dashed semi-circle indicates one position (in this instance a retracted position, though it is understood that it simply indicates a second position different than the fully extended position being the solid line semi-circle.

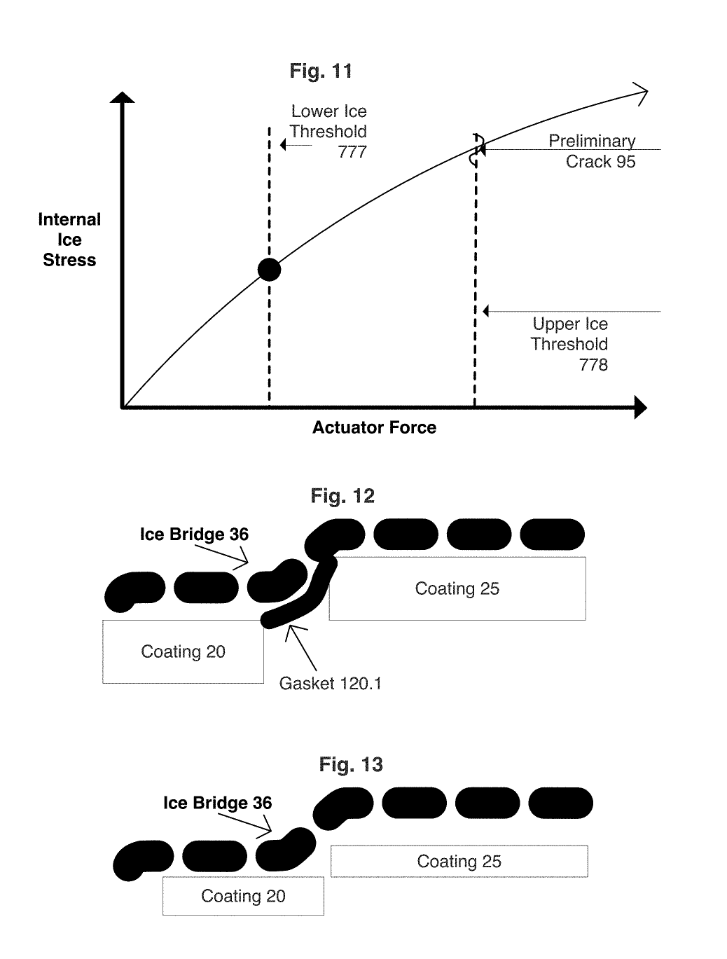

Turning to FIG. 11, depicts a numerical graph/chart showing the critical area between the lower ice force threshold 777 and the upper ice force threshold 778, with the latter occurring at the point in which a preliminary crack 95 (in this instance different than an ice bridging crack where a further break is desired) would propagate thus preventing the ice sheet/film from propagating the desired delamination further to remove the ice buildup throughout the coated section (a.k.a. first coated section 25, though not shown). The graph is the actuator force (X axis) as a function of the internal ice stress (Y axis). The utilization of this graph is by the active control system such that the ice buildup is sufficient to have an internal ice stress/strength to not break/stop the ice from further delaminating throughout the desired ice removal area.

Turning to FIG. 12, depicts the diminishing ice bridge 36 thickness due to the elongation of the ice buildup along the gasket 120.1, which also serves to limit ice buildup between the first coated section 25 and the second coated (or un-coated) section 20 relative to FIG. 13 not having a gasket where no elongation takes place thin the ice buildup thickness in between the ice bridging areas of the two respective first and second sections.

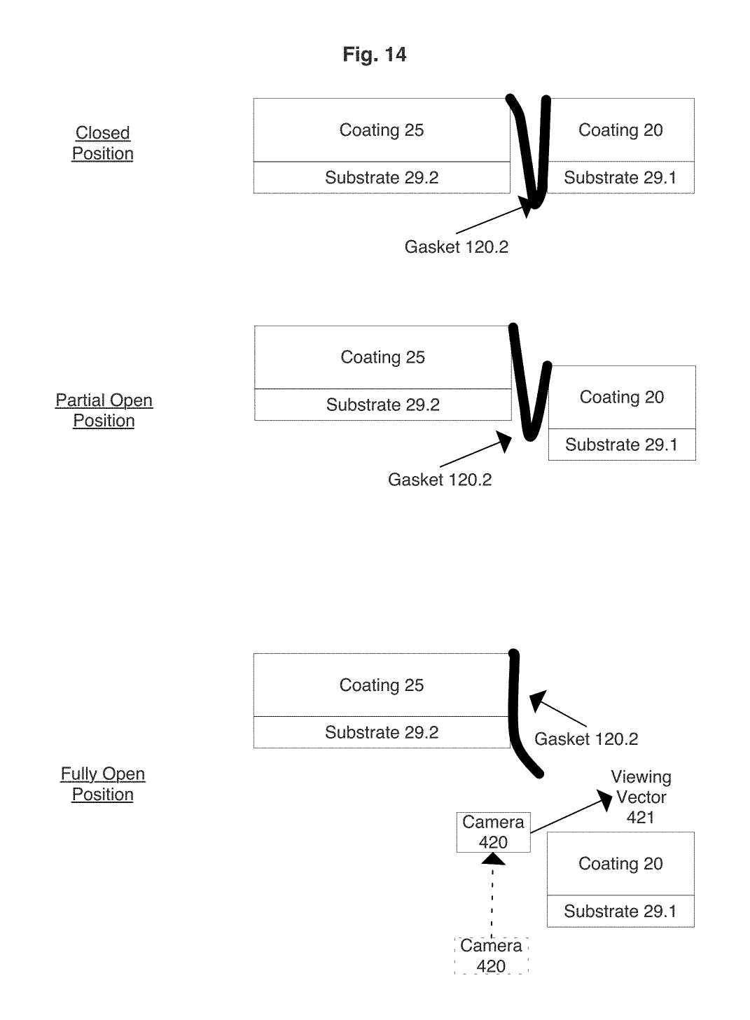

Turning to FIG. 14, depicts the range of motion between a closed (normal position, such as the embodiment of an automobile in which a hidden sensor/camera 420 is extended into its active functioning position indicated by the solid outlined camera 420 block as compared to the retracted position (its non-active position) indicated by the dashed outline. The gasket 120.2 in its closed position is in a U-shape to limit ice buildup in between the first and second sections (25 and 20 respectively), as it moves to an intermediary position where the U-shape is elongated with the gasket in structural communication with the first coated section 25. The fully open position has the gasket in its fully extended (more “L” shape) that enables upon retracting back into the closed position for the fixed (at least relative to the first section) second section to force the gasket back into its U-shape, while also providing a space for the camera/sensor 420 to perform its active function of viewing at its viewing vector 421.

What is claimed is:

1. An icephobic device having a total substrate area exposed to icing environmental conditions, comprised of at least one portion of the total substrate area having an icephobic coating, further comprised of an ice removal mechanism whereby the ice removal mechanism physically displaces an ice buildup and whereby an initial displacement area of the ice buildup from the at least a portion of the icephobic coating propagates beyond the initial displacement area of the ice buildup by an ice release propagation area and whereby the ice release propagation area is at least 5 percent of the initial displacement area.

2. The icephobic device according to claim 1 wherein the ice removal mechanism is any mechanism that creates a physical force onto the ice buildup whether the physical force is a shear or tangential force including the physical force from an external airflow, a flexing of an at least one structural element within the icephobic device due to rotational forces or an external airflow force acting on the icephobic device, an external gravitational force due to increased mass loading from the ice buildup, or the combination of rotational force and gravitational force.

3. The icephobic device according to claim 1 wherein the total substrate area is comprised of a first portion coating within the total substrate area having a first coating ice adhesion strength, and a second portion coating within the total substrate area having a second coating ice adhesion strength whereby the second coating ice adhesion strength is at least 10 percent higher than the first coating ice adhesion strength, and whereby the ice removal mechanism is in physical contact with the first portion coating and applies the physical force onto the ice buildup on the at least the first portion coating.

4. The icephobic device according to claim 3 wherein the second portion coating and the first portion coating are in a matrix pattern.

5. The icephobic device according to claim 4 whereby the second portion coating reduces an effective width of the total substrate area into a series of first portion coating, and whereby the effective width is at least less than half of the total substrate area width.

6. The icephobic device according to claim 3 ice removal mechanism creates a physical force on the ice buildup at an angle of at least 5 degrees upwards from the first portion coating towards the second portion coating.

7. The icephobic device according to claim 6 physical force applied on the ice buildup is at least 0.01 psi greater than required to displace the ice buildup and at least 0.01 psi lower than required to crack the ice on the first portion coating.

8. The icephobic device according to claim 6 physical force applied on the ice buildup is at least 0.01 psi greater than required to displace the ice buildup, at least 0.01 psi lower than required to crack the ice on the first portion coating, and at least 0.01 psi lower than required to crack the ice on the second portion coating.

9. The icephobic device according to claim 6 further comprised of a control system having at least one ice thickness sensor whereby the control system controls an actuator to exert the physical force applied on the ice buildup by the ice removal mechanism.

10. The icephobic device according to claim 8 whereby the actuator exerts a pulling force on the ice buildup prior to exerting a pushing force on the ice buildup operable as a method to increase by at least 0.01 inches a crack in the ice buildup.

11. The icephobic device according to claim 10 whereby the crack in the ice buildup is within an ice bridging area whereby the ice bridging area overlaps by at least 0.001 inches the first portion coating and the second portion coating.

12. The icephobic device according to claim 10 further comprised of a resistive element between the first portion coating and the second portion coating operable to create a preliminary crack in the ice buildup.

13. The icephobic device according to claim 10 further comprised of an infrared emitter, including an infrared LED, between the first portion coating and the second portion coating operable to create a preliminary crack in the ice buildup.

14. The icephobic device according to claim 1 further comprised of an at least one ice bridging preventer.

15. The icephobic device according to claim 1 further comprised of an at least one ice crack propagator.

16. The icephobic device according to claim 15 wherein the at least one ice crack propagator is in physical contact with the first portion coating of the total surface area.

17. The icephobic device according to claim 16 wherein the first portion coating of the total surface area tapers down to a diminishing width towards the at least one ice crack propagator.

18. The icephobic device according to claim 17 wherein the first portion coating is further comprised of a resistive layer below the second portion coating.

19. The icephobic device according to claim 1 further comprised of an at least one ice bridging preventer and an at least one ice crack propagator whereby the at least one ice bridging preventer reduces by at least 0.001 inches an ice buildup thickness over the at least one ice crack propagator.

20. An icephobic device having a total surface area exposed to icing environmental conditions, whereby a first portion of the total surface area is separated by a second portion (this is the portion that moves, preferably) of the total surface area, whereby a third portion of the total surface area is in between the first portion and the second portion of the total surface area, and whereby the third portion of the total surface area has a third portion height and a third portion area and the third portion is further comprised of an icephobic coating on at least 10 percent of the third portion area, whereby the icephobic device is further comprised of a control system operable to control an actuator to displace a top surface of the first portion to a top surface of the second portion.

21. The icephobic device according to claim 20 wherein the third portion is an icing bridge preventing device.

22. The icephobic device according to claim 21 wherein the third portion is further comprised of a hydrophobic coating to limit water or melted ice from subsequently forming ice below the third portion and either the first portion or the second portion.

23. The icephobic device according to claim 20 wherein the icephobic coating on the third portion is shielded by at least one of the first portion and the second portion from environmental conditions when the second portion is in a retracted height position.

24. The icephobic device according to 20 wherein the icephobic coating on the third portion is comprised of a first third portion icephobic coating and a second third portion icephobic coating, wherein an ice adhesion strength of the first third portion icephobic coating is at least 5 percent lower than an ice adhesion strength of the second third portion, and wherein first third portion icephobic coating is at least 0.001 inches above the second third portion icephobic coating in height whereby the first third portion icephobic coating is at least 0.001 inches closer to a position of the icing environmental conditions than the second third portion icephobic coating.
